(19) United States
(12) Patent Application Publication
(10) Pub. No.: US 2026/0167847 A1
(43) Pub. Date: Jun. 18, 2026

(54) PAPER TAPE

(71) Applicant: Supastrip Inc., South Chesterfield, VA (US)

(72) Inventors: Darren CROWDER, Nottingham (GB); Chris MARSHALL, Nottingham (GB)

(21) Appl. No.: 19/109,669

(22) PCT Filed: Sep. 7, 2023
(86) PCT No.: PCT/GB2023/052304

§ 371 Date: Mar. 7, 2025

(30) Foreign Application Priority Data
Sep. 8, 2022 (GB) 2213165.0

(51) Int. Cl. C09J 7/29; B32B 7/06; B32B 7/12; B32B 27/10; B65D 5/54; C09J 7/20; C09J 7/40

(52) U.S. Cl. CPC C09J 7/29; B32B 7/06; B32B 7/12; B32B 27/10; B65D 5/542; C09J 7/201; C09J 7/401; B32B 2255/12; B32B 2255/26; B32B 2307/718; B32B 2405/00; C09J 2301/414; C09J 2400/283; C09J 2483/005

(57) ABSTRACT

A tape comprising: a core comprising a layer of paper material; the layer of paper material comprising a coating composition disposed on a surface of the layer of paper material; a release agent layer comprising a release agent; and an adhesive layer comprising an adhesive; wherein the core is between the release agent layer and the adhesive layer.

### FIELD OF THE INVENTION

The present invention relates to tapes, tear tapes, packaging including the tapes or tear tapes, and their methods of production. For example, the present invention relates to paper tapes, paper tear tapes, packaging including such tapes or tear tapes, and their methods of production.

### BACKGROUND

Single use plastic products present a growing environmental problem affecting the planet's aquatic and terrestrial environments. Single use plastic products are products which are used once or used a small number of times and then discarded. Examples of single use plastic products include drinking straws, product packaging and carrier bags. Single use plastic products may be made from plastic materials that are recyclable; however, significant quantities of single use plastic products are disposed in landfill sites or make their way into rivers, lakes and oceans. Typical polymers used to create single use plastic products include polyethylene, polypropylene and polyester. Such polymers are not biodegradable and may form small beads or microparticles (so called microplastics) when exposed to the oceanic or terrestrial environment.

Research has been carried out to modify existing plastic products so that these are biodegradable, for example by composting processes. However, many of these polymers are not biodegradable in water and in anaerobic environments such as the deep ocean. Many biodegradable plastic materials are also not recyclable and can contaminate recyclable plastics or paper materials causing problems for existing plastic and paper recycling processes and infrastructure.

With the recent increase in popularity of online shopping, there has been a significant increase in the amount of cardboard packaging used to protect and house products for delivery to the consumer. Frequently, such packaging will include a tear tape attached to the packaging substrate which assists the user in opening the package. Typically, a tear tape will be adhered to an inside surface of the packaging and include a tab that protrudes from the outside of the packaging. The user can grasp the tab, and pull the tear tape through the packaging substrate to thereby form an opening in the packaging substrate. Tear tapes used with cardboard packaging need to be strong and resilient in order to form the opening in the packaging substrate without breaking.

Typically, tear tapes are formed from plastic materials, such as mono-oriented polypropylene, which while strong are not biodegradable or water soluble, and will contaminate cardboard and paper recycling if the tear tape remains adhered to the packaging destined for recycling. Plastic based tear tapes typically need to be segregated when packaging is recycled which complicates the recycling process.

Thus, there is a need for a tape, such as a tear tape, that possesses high strength, but is also recyclable using the repulping processes typically used for recycling paper and card products.

### SUMMARY OF THE INVENTION

In an aspect of the present invention, there is provided a tape comprising: a core comprising a layer of paper material; a release agent layer comprising a release agent; and an adhesive layer comprising an adhesive; wherein the core is between the release agent layer and the adhesive layer.

The applicant has found that a tape according to the present invention has high strength properties making it suitable for use as a tear tape, while being recyclable using repulping processes typically used in the recycling industry. The inclusion of a core comprising a layer of paper material provides sufficient strength and durability for use as a tear tape, while enabling the tape to be easily recycled using standard repulping recycling technology known in the art. Additionally, the applicant has found that the tape according to the present invention has high strength properties without the need for a core including multiple layers laminated together.

The core may comprise a single layer of paper material.

The layer of paper material may be a layer of paper. The layer of paper may be a sheet of paper. The paper may be Kraft paper, crepe paper, card or cardboard. Preferably, the paper is Kraft paper. The layer of paper may be derivable from (for example derived from) pure white Kraft pulp. The layer of paper may comprise primary fibres, for example the layer of paper may comprise predominantly primary fibres. The layer of paper may comprise unbleached or bleached fibres.

The layer of paper may be calendared. The applicant has found that calendaring the layer of paper improves the smoothness of the layer of paper and also reduces the thickness of the layer of paper.

The layer of paper material may be coated.

The layer of paper material may comprise a layer of a coating composition disposed on a surface of the paper material. For example, the layer of paper material may comprise a layer of paper as defined above and a layer of coating composition disposed on a surface of the layer of paper. The coating composition may be disposed on the entire surface of the layer of paper material, for example disposed evenly over the entire surface of the layer of paper material.

The coating composition may comprise a sizing agent. For example, the layer of paper material may be coated with a sizing agent. The layer of paper material may comprise a layer, comprising a sizing agent, disposed on a surface of the paper material.

The coating composition may comprise a filler and a binder. The filler may be selected from one or more of a clay, kaolin, bentonite, a carbonate, such as calcium carbonate, talk, silica, and titanium dioxide. The binder may be selected from one or more of a starch, polyvinyl alcohol, carboxyl methyl cellulose, an acrylic based material and a latex material. The acrylic based material may be a styrene acrylate. The latex material may be a synthetic rubber latex material such as a styrene butadiene rubber material. For example, the binder may be a styrene butadiene rubber or a styrene acrylate. The coating composition may comprise a clay. The coating composition may comprise clay and a styrene butadiene rubber material. For example, the layer of paper material may be a clay coated paper.

The layer of coating composition may be between the layer of paper material and the release agent layer.

The layer of paper material may comprise a layer of Kraft paper and a layer of coating composition disposed on a surface thereof, wherein the layer of coating composition comprises a styrene butadiene rubber binder and clay.

The coating composition may provide a smooth surface on the layer of paper material which assists further printing or application of the release agent or other components.

The layer of coating composition may have a basis weight of from 10 to 20 g/m², for example from 11 to 19 g/m², for example from 12 to 18 g/m², for example from 13 to 17 g/m², for example from 14 to 16 g/m², for example 15 g/m².

The paper may have a basis weight of from 80 to 110 g/m², for example from 91 to 109 g/m², for example from 92 to 108 g/m², for example from 93 to 107 g/m², for example from 94 to 106 g/m², for example from 95 to 105 g/m², for example from 96 to 104 g/m², for example from 97 to 103 g/m², for example from 98 to 102 g/m², for example from 99 to 101 g/m², for example 100 g/m².

In the case of the layer of paper material comprising a layer of coating composition disposed on a surface thereof, the total basis weight of the layer of paper material and the coating composition may be from 80 to 165 g/m², for example from 80 to 150 g/m², for example from 80 to 140 g/m², for example from 95 to 130 g/m², for example from 101 to 129 g/m², for example from 102 to 128 g/m², for example from 103 to 127 g/m², for example from 104 to 126 g/m², for example from 105 to 125 g/m², for example from 106 to 124 g/m², for example from 107 to 123 g/m², for example from 108 to 122 g/m², for example from 109 to 121 g/m², for example from 110 to 120 g/m², for example from 111 to 119 g/m², for example from 112 to 118 g/m², for example from 113 to 117 g/m², for example from 114 to 116 g/m², for example 115 g/m².

The layer of paper may have a thickness of from 90 to 180 μm, for example from 100 to 170 μm, for example from 100 to 160 μm, for example from 100 to 150 μm, for example from 100 to 140 μm, for example from 100 to 130 μm, for example from 100 to 120 μm, for example from 105 to 115 μm, for example 110 μm.

Basis weight may be determined using a standard method known in the art such as according to ISO 536.

The layer of paper material (for example a layer of paper comprising a layer of coating composition disposed on a surface thereof) may have a percentage elongation in the machine direction of 8 to 15%, for example 8 to 14%, for example 9 to 13%, for example 12%. The layer of paper material (for example a layer of paper comprising a layer of coating composition disposed on a surface thereof) may have a percentage elongation in the cross direction of 8 to 15%, for example 8 to 12%, for example 9 to 11%, for example 10%.

Herein machine direction means the longitudinal direction of the tape, and cross direction means the direction in the same plane as the machine direction but perpendicular to the machine direction.

Percentage elongation may be determined using a standard method known in the art such as according to ISO 1924-3.

Percentage elongation may be defined as the amount by which a sample will elongate until fracture relative to the original dimension of the sample before elongation.

The layer of paper material (for example a layer of paper comprising a layer of coating composition disposed on a surface thereof) may have a tensile strength in the machine direction of at least 8 kN/m, for example at least 9 kN/m, for example at least 10 kN/m.

The layer of paper material (for example a layer of paper comprising a layer of coating composition disposed on a surface thereof) may have a tensile strength in the cross direction of at least 3 kN/m, for example at least 4.5 kN/m.

Tensile strength may be defined as the maximum tensile force per unit width that a sample will withstand before breaking.

Tensile strength may be determined using a standard method known in the art such as according to ISO 1924-3.

The layer of paper material (for example a layer of paper comprising a layer of coating composition disposed on a surface thereof) may have a tear strength in the machine direction of at least 900 mN, for example at least 1000 mN, for example at least 1100 mN.

The layer of paper material (for example a layer of paper comprising a layer of coating composition disposed on a surface thereof) may have a tear strength in the cross direction of at least 800 mN, for example at least 900 mN, for example at least 1000 mN, for example at least 1100 mN, for example at least 1200 mN, for example at least 1300 mN, for example at least 1400 mN, for example at least 1500 mN, for example at least 1600 mN, for example at least 1700 mN, for example at least 1800 mN.

Tear strength may be determined using a standard method known in the art such as according to ISO 1974.

Tear strength may be defined as the mean force required to continue tearing started by an initial cut in a sample.

The applicant has found that the tensile strength, percentage elongation and tear strength properties exhibited by the paper layer lead to the tape having excellent machine direction and cross direction strength properties. These properties make the tape particularly suitable in tear tape applications.

The release agent may comprise a silicon based material, for example a silicone polymer. The release agent may be applied as a solvent based silicone system. The release agent may form a release agent layer following application and curing.

The release agent layer may have a basis weight of from 0.1 to 0.3 g/m², for example 0.2 g/m².

If the tape is wound onto a reel, then the release agent layer will contact the adhesive layer. Accordingly, the release agent layer facilitates removal of the tape from the wound reel and prevents the tape from permanently adhering to itself when wound onto a reel.

The adhesive may comprise an aqueous adhesive, for example an aqueous based dispersion adhesive. The adhesive layer may comprise a polymer formed from an acrylic ester and vinyl acetate. The adhesive layer may be applied as an aqueous dispersion of a polymer formed from an acrylic ester and vinyl acetate.

The adhesive layer may have a basis weight of from 25 to 31 g/m², for example from 26 to 30 g/m², for example from 27 to 29 g/m², for example 28 g/m².

The tape may comprises a primer layer comprising a primer, wherein the primer layer is between the core and the release agent layer and/or the primer layer is between the core and the adhesive layer.

The tape may comprise a first primer layer comprising a primer, and a second primer layer comprising a primer; wherein the first primer layer is between the core and the release agent layer, and the second primer layer is between the core and the adhesive layer.

The release agent layer may be disposed on the surface of the first primer layer. The adhesive layer may be disposed on the surface of the second primer layer.

The first primer layer may be configured to increase adherence of the core to the release agent layer. For example, the first primer layer may be configured to increase adherence of the layer of paper material, according to any statement above, to the release agent layer.

In the case of a core which comprises a layer of coating composition disposed on a surface of the layer of paper material, the first primer layer may be disposed on the surface of the layer of coating composition. For example, the first primer layer may be disposed on the entire surface of the layer of coating composition.

The applicant has found that inclusion of a primer layer between the layer of coating composition and the release agent layer improves adherence of the release layer to the layer of coating composition, and helps to prevent compounds in the coating composition from disrupting the catalytic system used to cure the release agent layer during manufacture of the tape. The applicant has found that certain compounds in coating compositions, such as compounds found in certain clays, may act to poison the catalyst used to cure the release agent when forming the release agent layer. Accordingly, the first primer layer may act as a barrier between the layer of coating composition and the release agent to thereby prevent catalyst poisoning and facilitate formation of the release agent layer, as well as help to improve adherence of the release agent layer to the coating composition.

The second primer layer may be configured to increase adherence of the core to the adhesive layer. For example, the second primer layer may be configured to increase adherence of the layer of paper material, according to any statement above, to the adhesive layer.

In the case of a core which comprises a layer of coating composition disposed on a surface of the layer of paper material, the second primer layer may be disposed on the surface of the layer of paper material which is free from the coating composition. For example, the second primer layer may be disposed on the entire surface of layer of paper material which is free from the coating composition.

The applicant has found that the second primer layer assists with adherence of the adhesive layer to the layer of paper material and helps prevent excessive absorption of the adhesive into the layer of paper material. The layer of paper material may be porous, so in the absence of a primer, the paper may absorb adhesive which may disrupt the material properties of the paper and consequently the core.

The applicant has found that the combination of a primer and an aqueous based adhesive may improve the percentage elongation of the tape. Without being bound by theory, the applicant hypothesises that while the primer layer prevents significant absorption of adhesive into the layer of paper material, low level absorption of the aqueous adhesive into the layer of paper material may still occur which may impart a small change to the material properties of the layer of paper material causing an improvement to the percentage elongation of the tape.

The first primer layer may have a basis weight, for example a dry film weight of primer, of from 2 to 4 gm², for example from 2.5 to 3.5 gm², for example 3 gm².

The second primer layer may have a basis weight, for example a dry film weight of primer, of from 1 to 3 gm², for example from 1.5 to 2.5 gm², for example 2 gm².

The primer may comprise an acrylic based primer. The acrylic based primer may be derivable from (for example derived from) an aqueous based acrylic based primer composition or a solvent based acrylic based primer system.

The primer may comprise an ethylene methyl acrylate copolymer (EMA copolymer) and a ketonic resin. A ketonic resin is also known as a cyclohexanone-aldehyde resin, and is a condensation product of cyclohexanone and an aldehyde.

The primer may be derivable, for example derived, from a primer composition comprising an ethylene methyl acrylate copolymer, a ketonic resin and a solvent. For example, the solvent may comprise ethanol and ethyl acetate. For example, the primer composition may comprise an ethylene methyl acrylate copolymer, a ketonic resin, ethanol and ethyl acetate.

The primer composition may be applied to each surface of the core, for example to each surface of the layer of paper material, such that the solvent evaporates leaving a primer layer, for example comprising the methyl acrylate copolymer and the ketonic resin.

The first primer layer may be disposed on a first surface of the core and the second primer layer may be disposed on a second surface of the core. For example, the first primer layer may be disposed on a first surface of the layer of paper material and the second primer layer may be disposed on a second surface of the layer of paper material. Each primer layer may be disposed on the entirety of each surface of the core, for example on the entirety of each surface of the layer of paper material. In the case of a core which comprises a layer of paper material in which a layer of coating composition is disposed on the surface thereof, the first primer layer may be disposed on the surface of the layer of coating composition. For example, the first primer layer may be disposed on the entire surface of the layer of coating composition.

In the case of a core which comprises a layer of paper material in which a layer of coating composition is disposed on a surface thereof, the second primer layer may be disposed on the surface of the layer of paper material which is free from the layer of coating composition.

The tape may comprise a core comprising a layer of paper; a layer of coating composition disposed on a first surface of the layer of paper; a first primer layer comprising a primer, the first primer layer disposed on the layer of coating composition; a second primer layer comprising a primer, the second primer layer disposed on the second surface of the layer of paper; an adhesive layer comprising an adhesive, the adhesive layer disposed on the second layer of primer; and a release agent layer comprising a release agent, the release agent layer disposed on the first primer layer. The layer of paper, layer of coating composition, first primer layer, second primer layer, adhesive layer and release agent layer may be as defined according to any statement set out above.

The tape according to any statement herein may be a reinforcing tape.

Preferably, the tape according to any statement herein is a tear tape.

The tape may have a total basis weight of from 120 to 170 g/m², for example from 130 to 160 g/m², for example from 140 to 150 g/m², for example from 141 to 149 g/m², for example from 142 to 148 g/m², for example from 143 to 147 g/m², for example from 143 to 146 g/m², for example 145 g/m².

The tape may have a breaking strength in the machine direction of at least 18 kgf/25 mm.

Herein kgf/25 mm means kilogram of force applied to a sample having a width of 25 mm.

The breaking strength may be measured using a standard method known in the art such as according to standard AFERA 5004.

Breaking strength may be defined as the force per unit width that a sample will withstand before breaking.

The tape may have a percentage elongation in the machine direction of at least 8%, for example at least 10%.

The percentage elongation may be measured using a standard method known in the art such as according to standard AFERA 5004.

The tape may have a peel adhesion of at least 500 gf/25 mm, for example at least 600 gf/25 mm.

Peel adhesion may be defined as the force required to remove a sample from a stainless steel test plate.

Herein, gf/25 mm means the gram of force required to remove a 25 mm width sample from a stainless steel test plate from an angle of 180° under a controlled speed.

The peel adhesion may be measured using a standard method known in the art such as according to standard FINAT FTM1 (steel plate).

The tape may have a width of from 3 to 8 mm, for example 4 to 7 mm, for example 4, 5 or 6 mm.

The tape may be repulpable. For example, the tape may be repulpable using repulping processes known in the art.

In a further aspect of the invention, there is provided a wound reel of tape comprising the tape according to any statement herein wound onto a spool.

In a further aspect of the invention there is provided packaging comprising: a substrate; and the tape according any statement herein (for example a tear tape), wherein the tape is adhered to the substrate by the adhesive layer; and wherein the substrate and tape are configured such that the tape can be pulled through the substrate to thereby form an opening in the substrate.

The substrate may be comprises card, paper, Kraft paper, cardboard or a polymer film. Preferably, the substrate comprises card, paper, kraft paper or cardboard.

In a further aspect of the invention, there is provided a method of making a tape comprising: forming a sheet material by advancing a web of core material, wherein the core material comprises a layer of paper material; applying an adhesive to a first surface of the layer of paper material to thereby form an adhesive layer, applying a release agent to the second surface of the layer of paper material to thereby form a release agent layer, to thereby form a sheet material; and slitting the sheet material to form a tape.

The method may comprise applying a primer composition to each surface of the web of core material to thereby form a primer layer disposed on each surface of the web of core material, applying an adhesive to the surface of a primer layer to thereby form an adhesive layer, applying a release agent to the surface of a primer layer to thereby form a release agent layer, and to thereby form a sheet material.

The primer composition may be applied by a gravure process.

The method may comprise a step of drying following application of the primer.

The release agent may be applied by a gravure process.

The adhesive may be applied by a reverse gravure process.

The layer of paper material may be a layer of paper. The layer of paper may be a sheet of paper. The paper may be Kraft paper, crepe paper, card or cardboard. Preferably, the paper is Kraft paper. The layer of paper may be derivable from (for example derived from) pure white Kraft pulp. The layer of paper may comprise primary fibres, for example the layer of paper may comprise predominantly primary fibres. The layer of paper may comprise unbleached or bleached fibres.

The layer of paper may be calendared. The applicant has found that calendaring the layer of paper improves the smoothness of the layer of paper and also reduces the thickness of the layer of paper.

The layer of paper material may be coated.

The layer of paper material may comprise a layer of a coating composition disposed on a surface of the paper material. For example, the layer of paper material may comprise a layer of paper as defined above and a layer of coating composition disposed on a surface of the layer of paper. The coating composition may be disposed on the entire surface of the layer of paper material, for example disposed evenly over the entire surface of the layer of paper material.

The coating composition may comprise a sizing agent. For example, the layer of paper material may be coated with a sizing agent. The layer of paper material may comprise a layer, comprising a sizing agent, disposed on a surface of the paper material.

The coating composition may comprise a filler and a binder. The filler may be selected from one or more of a clay, kaolin, bentonite, a carbonate, such as calcium carbonate, talk, silica, and titanium dioxide. The binder may be selected from one or more of a starch, polyvinyl alcohol, carboxyl methyl cellulose, an acrylic based material and a latex material. The acrylic based material may be a styrene acrylate. The latex material may be a synthetic rubber latex material such as a styrene butadiene rubber material. For example, the binder may be a styrene butadiene rubber or a styrene acrylate. The coating composition may comprise a clay. The coating composition may comprise clay and a styrene butadiene rubber material. For example, the layer of paper material may be a clay coated paper.

The layer of paper material may comprise a layer of Kraft paper and a layer of coating composition disposed on a surface thereof, wherein the layer of coating composition comprises a styrene butadiene rubber binder and clay.

The layer of coating composition may have a basis weight of from 10 to 20 g/m², for example from 11 to 19 g/m², for example from 12 to 18 g/m², for example from 13 to 17 g/m², for example from 14 to 16 g/m², for example 15 g/m².

The paper may have a basis weight of from 80 to 110 g/m², for example from 91 to 109 g/m², for example from 92 to 108 g/m², for example from 93 to 107 g/m², for example from 94 to 106 g/m², for example from 95 to 105 g/m², for example from 96 to 104 g/m², for example from 97 to 103 g/m², for example from 98 to 102 g/m², for example from 99 to 101 g/m², for example 100 g/m².

In the case of the layer of paper material comprising a layer of coating composition disposed on a surface thereof, the total basis weight of the layer of paper material and the coating composition may be from 80 to 165 g/m², for example from 80 to 150 g/m², for example from 80 to 140 g/m², for example from 95 to 130 g/m², for example from 101 to 129 g/m², for example from 102 to 128 g/m², for example from 103 to 127 g/m², for example from 104 to 126 g/m², for example from 105 to 125 g/m², for example from 106 to 124 g/m², for example from 107 to 123 g/m², for example from 108 to 122 g/m², for example from 109 to 121 g/m², for example from 110 to 120 g/m², for example from 111 to 119 g/m², for example from 112 to 118 g/m², for example from 113 to 117 g/m², for example from 114 to 116 g/m², for example 115 g/m².

The layer of paper may have a thickness of from 90 to 180 μm, for example from 100 to 170 μm, for example from 100 to 160 μm, for example from 100 to 150 μm, for example from 100 to 140 μm, for example from 100 to 130 μm, for example from 100 to 120 μm for example from 105 to 115 μm, for example 110 pm.

Basis weight may be determined using a standard method known in the art such as according to ISO 536.

The layer of paper material (for example a layer of paper comprising a layer of coating composition disposed on a surface thereof) may have a percentage elongation in the machine direction of 8 to 15%, for example 8 to 14%, for example 9 to 13%, for example 12%. The layer of paper material (for example a layer of paper comprising a layer of coating composition disposed on a surface thereof) may have a percentage elongation in the cross direction of 8 to 15%, for example 8 to 12%, for example 9 to 11%, for example 10%.

Percentage elongation may be determined using a standard method known in the art such as according to ISO 1924-3.

Percentage elongation may be defined as the amount by which a sample will elongate until fracture relative to the original dimension of the sample before elongation.

The layer of paper material (for example a layer of paper comprising a layer of coating composition disposed on a surface thereof) may have a tensile strength in the machine direction of at least 8 kN/m, for example at least 9 kN/m, for example at least 10 kN/m.

The layer of paper material (for example a layer of paper comprising a layer of coating composition disposed on a surface thereof) may have a tensile strength in the cross direction of at least 3 kN/m, for example at least 4.5 kN/m.

Tensile strength may be defined as the maximum tensile force per unit width that a sample will withstand before breaking.

Tensile strength may be determined using a standard method known in the art such as according to ISO 1924-3.

The layer of paper material (for example a layer of paper comprising a layer of coating composition disposed on a surface thereof) may have a tear strength in the machine direction of at least 900 mN, for example at least 1000 mN, for example at least 1100 mN.

The layer of paper material (for example a layer of paper comprising a layer of coating composition disposed on a surface thereof) may have a tear strength in the cross direction of at least 800 mN, for example at least 900 mN, for example at least 1000 mN, for example at least 1100 mN, for example at least 1200 mN, for example at least 1300 mN, for example at least 1400 mN, for example at least 1500 mN, for example at least 1600 mN, for example at least 1700 mN, for example at least 1800 mN.

Tear strength may be determined using a standard method known in the art such as according to ISO 1974.

Tear strength may be defined as the mean force required to continue tearing started by an initial cut in a sample.

The release agent may comprise a silicon based material, for example a silicone polymer. The release agent may be applied as a solvent based silicone system. The release agent may form a release agent layer following the step of application and curing.

The release agent layer may have a basis weight of from 0.1 to 0.3 g/m², for example 0.2 g/m².

The adhesive may comprise an aqueous adhesive, for example an aqueous based dispersion adhesive. The adhesive layer may comprise a polymer formed from an acrylic ester and vinyl acetate. The adhesive layer may be applied as an aqueous dispersion of a polymer formed from an acrylic ester and vinyl acetate.

The adhesive layer may have a basis weight of from 25 to 31 g/m², for example from 26 to 30 g/m², for example from 27 to 29 g/m², for example 28 g/m².

The first primer layer may have a basis weight, for example a dry film weight of primer, of from 2 to 4 gm², for example from 2.5 to 3.5 gm², for example 3 gm².

The second primer layer may have a basis weight, for example a dry film weight of primer, of from 1 to 3 gm², for example from 1.5 to 2.5 gm², for example 2 gm².

The primer may comprise an acrylic based primer. The acrylic based primer may be derivable from (for example derived from) an aqueous based acrylic based primer composition or a solvent based acrylic based primer system.

The primer may comprise an ethylene methyl acrylate copolymer (EMA copolymer) and a ketonic resin. A ketonic resin is also known as a cyclohexanone-aldehyde resin, and is a condensation product of cyclohexanone and an aldehyde.

The primer may be applied via a primer composition comprising an ethylene methyl acrylate copolymer, a ketonic resin and a solvent. For example, the solvent may comprise ethanol and ethyl acetate. For example, the primer composition may comprise an ethylene methyl acrylate copolymer, a ketonic resin, ethanol and ethyl acetate.

The primer composition may be applied to each surface of the core, for example to each surface of the layer of paper material, such that the solvent evaporates leaving a primer layer, for example comprising the methyl acrylate copolymer and the ketonic resin.

Basis weight may be determined using a standard method known in the art such as according to ISO 536.

Basis weight may be determined by preparing a sample having given dimensions. The sample is weighed using a balance and the total basis weight calculated from the surface area of the sample and its mass. The basis weight of a given layer can be determined by comparing the mass with and without the given layer while keeping the sample area constant.

Percentage elongation may be determined using a standard method known in the art such as according to ISO 1924-3.

Tensile strength may be determined using a standard method known in the art such as according to ISO 1924-3.

Percentage elongation and tensile strength may be determined according to the following method. A test piece of given dimensions is strained to break at a constant rate of elongation using a testing machine that automatically records both the tensile force and the elongation. From the recorded data, the tensile strength and percentage elongation can be calculated. The testing machine applies strain to a test piece at a constant rate of elongation of 100 mm/min+−10 mm/min to record both the tensile force and the elongation.

Tear strength may be determined using a standard method known in the art such as according to standard ISO 1974.

The tear strength may be measured by making an initial cut in the test piece which is then torn out of plane through a given distance along one single tear line using a pendulum. The work done in tearing the test piece is measured as the loss in energy of the pendulum, and the tear strength is calculated by dividing the work done by the distance torn and the number of sheets of paper in the test piece.

### DETAILED DESCRIPTION

Preferred embodiments of the present invention will now be described, by way of example only, with reference to the accompanying drawings, in which:

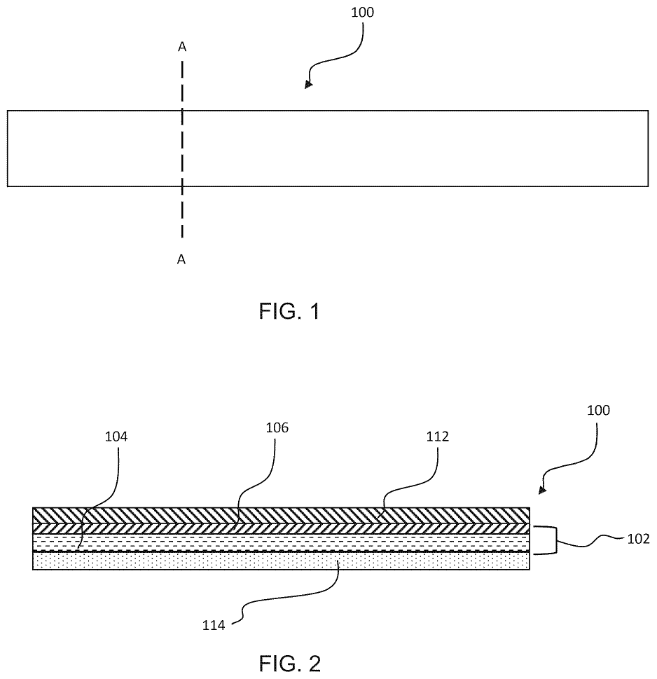

FIG. 1 is a top view of a tape according to the present invention;

FIG. 2 is a sectional view of an embodiment of the tape along line A-A in FIG. 1;

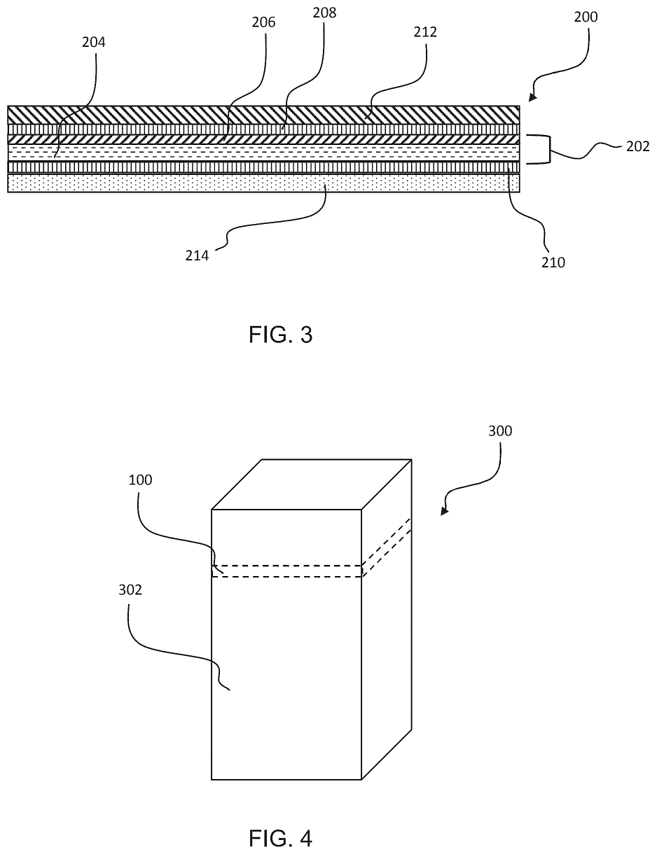

FIG. 3 is a sectional view of a further embodiment of the tape along line A-A in FIG. 1;

FIG. 4 is a perspective view of packaging according to the present invention;

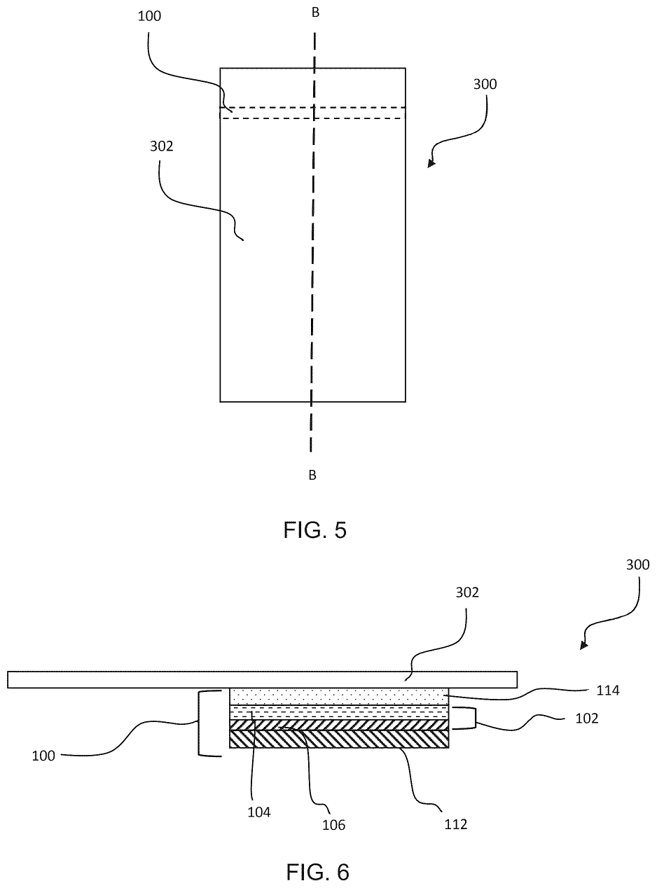

FIG. 5 is a front view of the packaging shown in FIG. 4;

FIG. 6 is a partial sectional view of an embodiment of the packaging shown in FIG. 5 along line B-B;

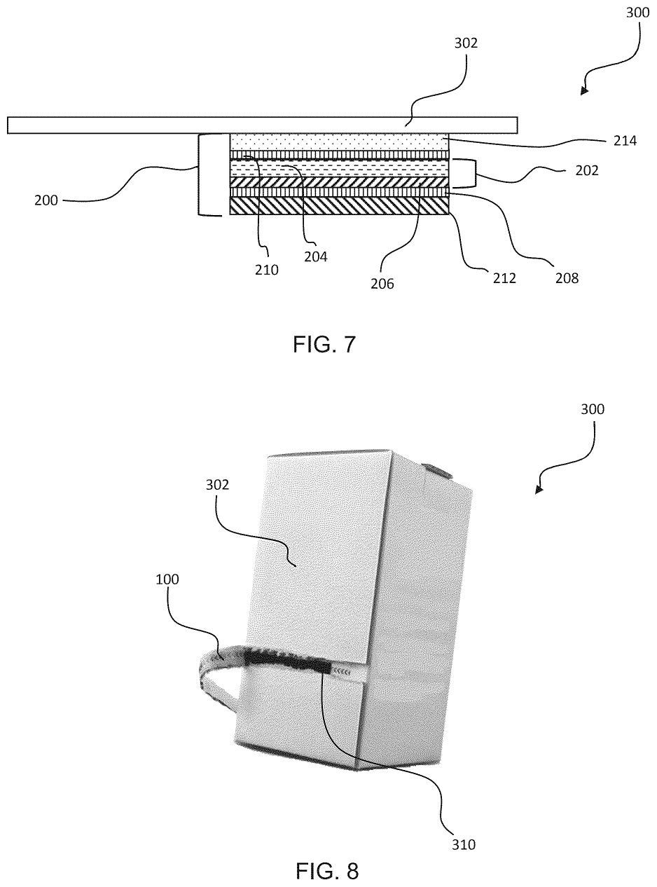

FIG. 7 is a partial sectional view of a further embodiment of the packaging shown in FIG. 5 along line B-B; and

FIG. 8 is a perspective view of the packaging shown in FIG. 4 in use.

FIG. 1 shows a top view of a tape 100. The tape may be a tear tape.

FIG. 2 illustrates a sectional view of an embodiment of the tape 100 along line A-A shown in FIG. 1. As shown in FIG. 2, the tape comprises a core 102. The core 102 comprises a sheet of paper 104, such as Kraft paper, and a layer of a coating composition in the form of a clay material 106. The layer of clay material 106 is disposed on a first surface of the sheet of paper 104. The layer of clay material comprises a styrene butadiene rubber binder together with a clay filler. A layer of adhesive 114 is disposed on the surface of the sheet of paper that is free of the layer of clay material. The adhesive comprises an aqueous adhesive, for example an aqueous based dispersion adhesive. Disposed on the surface of the layer of clay material 106 is a layer of release agent 112. The release agent comprises a silicone based material.

The tear tape 100 can be manufactured according to the following process.

A sheet of paper material, such as Kraft paper, is advanced longitudinally. The sheet of paper includes a layer of clay material disposed on a first surface of the sheet of paper material. At an adhesive application station, a layer of adhesive is applied to the surface of the sheet of paper that is free from the clay material using a reverse gravure process. At a release agent application station, a layer of release agent composition is applied to the surface of the layer of clay material. The layer of release agent composition is allowed to cure to form a layer of release agent. The sheet material is slit in the longitudinal direction to thereby form a plurality of tapes. The tapes can be wound on to a spool, such that the adhesive layer contacts the release agent layer, to thereby form a wound reel of the tape.

FIG. 3 illustrates a sectional view of a further embodiment of the tape along the same line as shown in FIG. 1. As shown in FIG. 3, the tape comprises a core 202. The core 202 comprises a sheet of paper 204, such as Kraft paper, and a layer of a coating composition in the form of a clay material 206. The layer of clay material 206 is disposed on a first surface of the sheet of paper 204. The layer of clay material 206 comprises a styrene butadiene rubber binder together with a clay filler. A first primer layer 208 is disposed on the surface of the layer of clay material 206. A second primer layer 210 is disposed on the second surface of the sheet of paper 204. The second surface of the sheet of paper 204 is the surface that does not have the layer of clay material disposed thereon. The first and second primer layers comprise the same primer. The primer comprises an ethylene methyl acrylate copolymer (EMA copolymer) and a ketonic resin. A layer of adhesive 214 is disposed on the surface of the second primer layer 210. The adhesive comprises an aqueous adhesive, for example an aqueous based dispersion adhesive. Disposed on the surface of the first primer layer 208 is a layer of release agent 212. The release agent comprises a silicone based material.

The tear tape 200 can be manufactured according to the following process.

A sheet of paper material, such as Kraft paper, is advanced longitudinally. The sheet of paper includes a layer of clay material disposed on a first surface of the sheet of paper material. At a primer application station, a primer composition is applied to the surface of the layer of clay material using a gravure process to form a first primer layer. The same primer composition is also applied using a gravure process to the second surface of the sheet of Kraft paper to form a second primer layer. The primer composition is applied to the second surface of the sheet of Kraft paper either concurrently with application of the primer composition to the surface of the clay material or subsequently at a second primer application station.

Following application of the primer composition, the sheet is dried to remove the solvent from the primer composition. At an adhesive application station, a layer of adhesive is applied to the second primer layer using a reverse gravure process. At a release agent application station, a layer of release agent composition is applied to the first primer layer using a gravure process. The layer of release agent composition is allowed to cure to form a layer of release agent. The sheet material is slit in the longitudinal direction to thereby form a plurality of tapes. The tapes can be wound on to a spool, such that the adhesive layer contacts the release agent layer, to thereby form a wound reel of the tape.

FIG. 4 shows packaging 300. The packaging 300 includes a packaging substrate 302 and adhered to the underside of the packaging substrate 302 is a tear tape 100.

FIG. 5 shows a front view of the packaging 300 illustrated in FIG. 4.

FIG. 6 shows a partial sectional view of the packaging 300 along line B-B shown in FIG. 5. FIG. 6 shows the packaging substrate 302 which may be in the form of, for example, a sheet of cardboard. Adhered to the underside of the packaging substrate 302 is a tear tape 100. The tear tape 100 is adhered to the underside of the packaging substrate 302 by means of the adhesive layer 114. The tear tape 100 has the same configuration as described above with respect to FIG. 2.

The tear tape 100 may include a tab (not shown) that protrudes through the packaging substrate 302, for example via a slit in the packaging substrate. The tab may alternatively extend away from part of the packaging substrate at a position where part of the substrate joins another part of the substrate. The tab may include an adhesive deadening layer disposed on the surface of the adhesive layer 114 in only the region of the tab, such that the tab can be easily grasped by the user. Upon pulling the tab, the tear tape is pulled through the substrate 302 to thereby tear the substrate to form an opening in the substrate 302 and enable access to the contents within the packaging.

The applicant has found that the tear tape 100 has sufficient strength to be able to remain intact and pass through the packaging substrate to form an opening. In some configurations, the packaging substrate may include parallel rows of equally spaced apart slits or perforations either side of the tear tape which act to aide and guide the tearing of the packaging substrate.

The tear tape 100 may be assembled onto the packaging substrate 302 using standard techniques known in the art.

FIG. 7 shows a partial sectional view of the packaging 300 along line B-B shown in FIG. 5; however, the tear tape of FIG. 3 is adhered to the underside of packaging substrate rather than the tear tape of FIG. 2.

FIG. 7 shows the packaging substrate 302 which may be in the form of, for example, a sheet of cardboard. Adhered to the underside of the packaging substrate 302 is a tear tape 200. The tear tape 200 is adhered to the underside of the packaging substrate 302 by means of the adhesive layer 214. The tear tape 200 has the same configuration as described above with respect to FIG. 3.

The tear tape 200 may include a tab (not shown) that protrudes through the packaging substrate 302, for example via a slit in the packaging substrate. The tab may alternatively extend away from part of the packaging substrate at a position where part of the substrate joins another part of the substrate. The tab may include an adhesive deadening layer disposed on the surface of the adhesive layer 214 in only the region of the tab, such that the tab can be easily grasped by the user. Upon pulling the tab, the tear tape is pulled through the substrate 302 to thereby tear the substrate to form an opening in the substrate 302 and enable access to the contents within the packaging.

The applicant has found that the tear tape 200 has sufficient strength to be able to remain intact and pass through the packaging substrate to form an opening. In some configurations, the packaging substrate may include parallel rows of equally spaced apart slits or perforations either side of the tear tape which act to aide and guide the tearing of the packaging substrate.

The tear tape 200 may be assembled onto the packaging substrate 302 using standard techniques known in the art.

FIG. 8 shows packaging 300 in the form of a carton comprising a cardboard packaging substrate 302, to the underside of which a tear tape 100 is adhered. FIG. 6 shows the packaging 300 in an open configuration after the tear tape 100 has been pulled to thereby tear the cardboard packaging substrate and form an opening 310.

For packaging substrates formed of paper, card, cardboard and the like, the tear tape 100 or 200 can be recycled together with the packaging substrate using standard repulping processes known in the art. The tear tape 100 or 200 does not need to be separated from the packaging substrate, and the tear tape will not contaminate recyclable packaging substrate materials with non-recyclable materials, which can be a problem associated with tear tapes comprising polymeric films such as polyethylene.

### EXAMPLES

### Example 1

A tear tape was assembled, according to the method described above, having the configuration shown in FIG. 3.

The tear tape included a core formed from a layer of Kraft paper having a basis weight of 100 g/m² The layer of kraft paper was coated with a clay coating composition. The clay coating composition included a SBR binder together with a clay filler. The coating composition had a basis weight of 15 g/m², and the total basis weight of the coated kraft paper was 115 g/m². A first primer layer was disposed on the surface of the layer of clay material, and a second primer layer was disposed on the surface of the layer of Kraft paper without the clay coating. The primer comprised an ethylene methyl acrylate copolymer (EMA copolymer) and a ketonic resin. The first primer layer had a basis weight of 3 g/m². A release agent layer comprising silicone was disposed on the first primer layer. The release agent layer had a basis weight of 2 g/m². An adhesive layer comprising an aqueous based dispersion adhesive was disposed on the second primer layer. The adhesive layer had a basis weight of 28 g/m². The configuration is summarised in table 1 below.

TABLE 1

Silicone release layer - basis weight 0.1 g/m²
Primer Layer 1 - basis weight 3 g/m²
Layer of clay material - basis weight 15 g/m²
Kraft Paper - basis weight 100 g/m²
Primer Layer 2 - basis weight 2 g/m²
Aqueous based dispersion Adhesive layer - basis weight 28 g/m²

### Example 2—General Procedure for Repulpability Assessment

A 55 g sample of the test material was oven dried.

The sample was pulped according to the method of ISO 5263-1.

The sample was added to 2 litres of water to achieve a 1.5% w/v pulp concentration. The mixture was heated to 40° C. and the sample subjected to agitation in a disintegrator for 10 minutes and 30,000 revolutions. The resulting pulp was diluted to 5 L to achieve a pulp concentration of 1% w/v.

The resulting pulp slurry was screened using a course Sommerville screen having a hole size of 5 mm. The pulp slurry was passed through the screen for 5 minutes at a flow rate of 8 litres per minute. The material retained on the screen was transferred to a filter paper, and mass analysis conducted.

The pulp slurry was also passed through a fine Sommerville screen having slot sizes of 150 μm. The pulp slurry was passed through the screen for 20 minutes at a flow rate of 8 litres per minutes. The fine screen was used to determine flake content and material retained on the screen could also be analysed to determine mass and surface area.

A macrostickies analysis was carried out according to ISO 15360 using a Sommerville screen having slit size 150 pm. Pulp slurry was passed through the screen for 20 minutes at a flow rate of 8 litres per minute. The material retained on the screen was transferred to a filter paper and heated under pressure. Sticky particles were identified and their number and area estimated. Stickies are defined as a diverse group of materials that are retained on a laboratory screen of given slot aperture (100 or 150 pm) and which adhere to objects which they touch.

### Example 3

The tear tape according to Example 1 was prepared. A cardboard packaging substrate, having a basis weight of 415 g/m² was obtained. The packaging substrate was air dried and the tear tape adhered to the packaging substrate. A 55 g sample of the packaging substrate and tear tape was oven dried. The sample included 54.55 g of packaging substrate and 0.55 g of the tear tape.

The sample was pulped according to the process of Example 2 at 40° C. for 10 minutes. The pulp was then analysed according to the screening procedure described in Example 2. Results of the test and analysis are set out below.

### Reference Example 1

As a control, a 55 g sample of the same cardboard packaging substrate as used in Example 3 was oven dried and subjected to the pulping process and analysis outlined in Example 2, except the sample was subjected to agitation in the disintegrator for 20 minutes rather than 10 minutes. Results of the test and analysis are set out below.

### Results

The results of the repulpability assessment, according to UNI 1743: MC501, are set out below in table 2.

TABLE 2

| | Course | Fibre | | | | |
|---|---|---|---|---|---|---|
| | rejects | flakes | Macrostickies | Sheet | Optical | Overall |
| Example | % | % | mm²/kg | adhesiveness | inhomogeneities | evaluation |
| 1 | 0 | 0.47 | 0 | No adhesion | Level 1 | Recyclable |
| | | | | | | with paper |
| | | | | | | Level A+ |
| Reference | 0 | 0 | 0 | No adhesion | Level 1 | Recyclable |
| 1 | | | | | | with paper |
| | | | | | | Level A+ |

Recyclability levels are defined in table 2 below.

TABLE 3

| | Recyclable with paper | | | | Non recyclable |
|---|---|---|---|---|---|
| Evaluation criteria | Level A+ | Level A | Level B | Level C | with paper |
| Course reject (%) | <1.5 | 1.5-10.0 | 10.1-20.0 | 20.1-40.0 | >40.0 |
| Macrostickies | <2,500 | 2,500-10,000 | 10,001-20,000 | 20,001-50,000 | >50,000 |
| area <2,000 μm | | | | | |
| (mm2/kg) | | | | | |
| Fibre flakes (%) | <5.0 | 5.0-15.0 | 15.1-40.0 | >40.0 | (—) |
| Adhesiveness | absent | absent | absent | absent | present |
| Optical inhomogeneities | Level 1 | Level 2 | Level 3 | Level 3 | (—) |

The tear tape according to Example 1 exhibited excellent repulpability properties when adhered to a packaging substrate, and demonstrated similar course rejects, fibre flakes and macrosktickie levels to the product packaging without the tear tape.

### Material Properties

The tear tape of Example 1 was subjected to testing for breaking strength, percentage elongation (elongation at break), and peel adhesion.

The breaking strength may be measured using a method according to standard AFERA 5004. The percentage elongation (elongation at break) may be measured according to standard AFERA 5004.

Breaking strength and percentage elongation were measured according to the following method.

A sample was prepared having a width of 24 mm and a length of 100 mm. The samples were conditioned for 20 minutes at 23° C. and at 50% relative humidity. A tensometer (Instron (RTM)) was set with a 100 kg load cell and a cross head speed of 200 mm/min. The jaws of the tensometer were separated by 100 mm and the test sample was clamped such that the longer edge was in the direction of movement of the tensometer cross head. The sample was elongated until fracture occurred, and data was recorded by the tensometer instrument. Multiple tests were carried out and an average breaking strength and percentage elongation were recorded.

The peel adhesion may be measured using a method according to standard FINAT FTM1 (steel plate). The peel adhesion was measured according to the following method.

The steel test plates were cleaned with acetone and dried. The plates were conditioned for 20 minutes at 23° C. and 50% relative humidity. A tape sample was prepared having a width of 25 mm. The adhesive surface of the sample was applied to the steel plate such that a free end of the sample protruded from the edge of the test plate. The sample was rolled for three complete oscillations using a calibrated 2 kg roller for 20 minutes at 23° C. and 50% relative humidity. The test plate was secured in the lower jaw of a tensometer (Instron (RTM)) and the free end of the tape sample was held in the upper jaw. A 100 kg load was applied to the tensometer and a cross head speed of 300 mm/min applied to peel the sample away from the steel plate. The mean force over the length of the sample was noted. Multiple tests were carried out and an average peel adhesion recorded.

The results of the above tests are set out below in table 4.

TABLE 4

| | |
|---|---|
| Breaking strength | >18 kgf/25 mm |
| Percentage elongation | >10% |
| Peel adhesion | >600 gf/25 mm |

The above material properties demonstrate that the tapes according to the invention have excellent strength properties which make them particularly suitable for use as tear tapes with card and cardboard packaging substrates having a high strength and tear resistance.

1. A tape comprising:
a core comprising a layer of paper material;
a release agent layer comprising a release agent; and
an adhesive layer comprising an adhesive;
wherein the core is between the release agent layer and the adhesive layer.

2. The tape according to claim 1, wherein the tape comprises a primer layer comprising a primer, wherein the primer layer is between the core and the release agent layer and/or the primer layer is between the core and the adhesive layer.

3. The tape according to claim 1, wherein the tape comprises a first primer layer comprising a primer, and a second primer layer comprising a primer; wherein the first primer layer is between the core and the release agent layer, and the second primer layer is between the core and the adhesive layer.

4. The tape according to claim 1, wherein the layer of paper material comprises a layer of a coating composition disposed on a surface of the layer of paper material.

5. The tape according to claim 4, wherein the layer of the coating composition is between the layer of paper material and the release agent layer.

6. The tape according to claim 4, wherein the coating composition comprises a binder and a filler.

7. The tape according to claim 6 wherein the binder comprises an acrylic material or a latex material, and the filler comprises a clay material.

8. The tape according to claim 4, wherein a total basis weight of the layer of paper material and the coating composition is from 95 to 130 g/m².

9. The tape according to claim 1, wherein the layer of paper material has a tensile strength in a machine direction of at least 8 kN/m; and/or a tensile strength in a cross direction of at least 3 kN/m; and/or a tear strength in the machine direction of at least 900 mN; and/or a tear strength in the cross direction of at least 1500 mN; and/or a percentage elongation in the machine direction of from 8 to 15%; and/or a percentage elongation in the cross direction of from 8 to 15%.

10. The tape according to claim 1, wherein the release agent comprises a silicon based material.

11. The tape according to claim 1, wherein the adhesive comprises an aqueous based dispersion adhesive.

12. The tape according to claim 3, wherein the first primer layer is disposed on a first surface of the core; and the second primer layer is disposed on a second surface of the core.

13. The tape according to claim 12, wherein the layer of paper material comprises a layer of coating composition disposed on a surface thereof; and wherein the first primer layer is disposed on the surface of the layer of coating composition, and the second primer layer is disposed on the surface of the layer of paper material free from coating composition.

14. The tape according to claim 13, wherein the release agent layer is disposed on the surface of the first primer layer, and the adhesive layer is disposed on the surface of the second primer layer.

15. The tape according to claim 3, wherein the first primer layer is configured to increase adherence of the layer of paper material to the release agent layer; and the second primer layer is configured to increase adherence of the layer of paper material to the adhesive layer.

16. The tape according to claim 3, wherein the first primer layer has a basis weight of from 2 to 4 g/m²; and wherein the second primer layer has a basis weight of from 1 to 3 g/m².

17. The tape according to claim 2, wherein the primer comprises an ethylene methyl acrylate copolymer and a ketonic resin.

18. The tape according to claim 2, wherein the primer is derivable from a primer composition comprising an ethylene methyl acrylate copolymer, a ketonic resin and a solvent.

19. A tape comprising:
a core comprising a layer of paper;
a layer of coating composition disposed on a first surface of the layer of paper;
a first primer layer comprising a first primer, the first primer layer disposed on the layer of coating composition;
a second primer layer comprising a second primer, the second primer layer disposed on a second surface of the layer of paper;
an adhesive layer comprising an adhesive, the adhesive layer disposed on the second primer layer; and
a release agent layer comprising a release agent, the release agent layer disposed on the first primer layer.

20. The tape according to claim 1, wherein the tape is a tear tape.

21. The tape according to claim 1, wherein the tape has a total basis weight of from 120 to 170 g/m².

22. The tape according to claim 1, wherein the tape has a breaking strength in a machine direction of at least 18 kgf/25 mm.

23. The tape according to claim 1, wherein the tape has a percentage elongation in a machine direction of at least 8%.

24. The tape according to claim 1, wherein the tape has a peel adhesion of at least 500 gf/25 mm.

25. A wound reel of tape comprising the tape according to claim 1 wound onto a spool.

26. A packaging comprising:
a substrate; and
the tape according to claim 1, wherein the tape is adhered to the substrate by the adhesive layer; and
wherein the substrate and the tape are configured such that the tape can be pulled through the substrate to thereby form an opening in the substrate.

27. The packaging according to claim 26, wherein the substrate comprises card, paper, Kraft paper, cardboard or a polymer film.

28. A method of making a tape comprising:
forming a sheet material by advancing a web of core material, wherein the core material comprises a layer of paper material;
applying an adhesive to a first surface of the layer of paper material to thereby form an adhesive layer, applying a release agent to a second surface of the layer of paper material to thereby form a release agent layer, to thereby form a sheet material; and
slitting the sheet material to form a tape.
